(19) United States
(12) Patent Application Publication
(10) Pub. No.: US 2025/0390103 A1
(43) Pub. Date: Dec. 25, 2025

(54) MOTION CONTROL SYSTEM, POSITION DETECTION ASSEMBLY, AND ROBOT

(71) Applicant: BEIJING GEEKPLUS TECHNOLOGY CO., LTD., Beijing (CN)

(72) Inventors: Bin AN, Beijing (CN); Shuai WANG, Beijing (CN); Shoujun QU, Beijing (CN)

(21) Appl. No.: 18/996,264

(22) PCT Filed: Aug. 23, 2023
(86) PCT No.: PCT/CN2023/114345

§ 371 Date: Jan. 17, 2025

(30) Foreign Application Priority Data
Sep. 2, 2022 (CN) 202211070833.6

(51) Int. Cl. G05D 1/617; B25J 9/16

(52) U.S. Cl. CPC G05D 1/617; B25J 9/1664; B25J 9/1694

(57) ABSTRACT

A motion control system includes: a position detection component, configured to output an absolute position signal, a first relative position signal and a second relative position signal, a driving component, configured to obtain the absolute position signal output by the position detection component, determine an abnormal situation of the position detection component based on the absolute position signal, and generate a motion stop command in case that the position detection component is determined to be abnormal; and a safety control component, configured to obtain the first relative position signal and the second relative position signal output by the position detection component, determine an abnormal situation of the position detection component based on the first relative position signal and the second relative position signal, and generate the motion stop command in case that the position detection component is determined to be abnormal.

### CROSS-REFERENCE TO RELATED APPLICATIONS

The application is a national stage entry under 35 U.S.C. § 371 of International Application No. PCT/CN2023/114345, filed on Aug. 23, 2023, which claims priority to Chinese Patent Application No. 202211070833.6, filed on Sep. 2, 2022, the entire disclosures of which are hereby incorporated herein by reference.

### TECHNICAL FIELD

The present disclosure relates to a field of automatic control technology, and specifically to a motion control system, a position detection component, and a robot.

### BACKGROUND

With rapid development of the computer technology, the Internet technology and the artificial intelligence technology, more and more automatic control devices are born, which are used in many aspects of people's life and work. An encoder is a key component in the automatic control devices, widely used in many areas such as an industrial robot, a computer numerical control machine tool, an automobile, and a medical device. The encoder is used to detect angular displacement, linear displacement and other position information of a measured object, and converts the position information into an electrical signal that is easy to handle so as to control motion of a device.

Since the encoder is a position feedback element of the motion of the device, a working state of the encoder may directly affect operation of the device. For example, an encoder output error may lead to abnormal motion of the device or even galloping, which may do harm to the device and people, so a fault state of the encoder is needed to be detected in time so that measures such as stopping the motion may be taken.

### SUMMARY

The embodiments of the present disclosure provide a motion control system, a position detection component, and a robot.

According to some embodiments of the present disclosure, a motion control system is provided, including a position detection component, a driving component, and a safety control component. The position detection component is configured to output an absolute position signal, a first relative position signal and a second relative position signal, in which the absolute position signal and the first relative position signal are output via a first position detection channel in the position detection component, and the second relative position signal is output via a second position detection channel in the position detection component: the driving component is configured to obtain the absolute position signal output by the position detection component, determine an abnormal situation of the position detection component based on the absolute position signal, and generate a motion stop command in case that the position detection component is determined to be abnormal; and the safety control component is configured to obtain the first relative position signal and the second relative position signal output by the position detection component, determine an abnormal situation of the position detection component based on the first relative position signal and the second relative position signal, and generate the motion stop command in case that the position detection component is determined to be abnormal.

According to some embodiments of the present disclosure, a position detection component is provided, including a first position detection channel and a second position detection channel. The first position detection channel is configured to detect an absolute position and a first relative position of a measured object, and generate and output an absolute position signal and a first relative position signal; and the second position detection channel is configured to detect a second relative position of the measured object, and generate and output a second relative position signal: in which the absolute position signal, the first relative position signal and the second relative position signal are configured to determine an abnormal situation of the position detection component.

According to some embodiments of the present disclosure, a robot is provided, including a motion control system and a motor: in which the motion control system includes a position detection component, a motor driving component and a safety control component: in which the position detection component is configured to output an absolute position signal, a first relative position signal and a second relative position signal, in which the absolute position signal and the first relative position signal are output via a first position detection channel in the position detection component, and the second relative position signal is output via a second position detection channel in the position detection component: the motor driving component is configured to obtain the absolute position signal output by the position detection component, determine an abnormal situation of the position detection component based on the absolute position signal, and trigger a motion stop command in case that the position detection component is determined to be abnormal: the safety control component is configured to obtain the first relative position signal and the second relative position signal output by the position detection component, determine an abnormal situation of the position detection component based on the first relative position signal and the second relative position signal, and send the motion stop command in case that the position detection component is determined to be abnormal; and the motor driving component is configured to control the motor to stop operating based on the motion stop command.

### BRIEF DESCRIPTION OF THE DRAWINGS

FIG. 1 is a schematic diagram of a position detection component according to some embodiments of the present disclosure.

FIG. 2 is a flowchart of a position detection method according to some embodiments of the present disclosure.

FIG. 3 is a schematic diagram of a motion control system according to some embodiments of the present disclosure.

FIG. 4 is a flowchart of a motion control method according to some embodiments of the present disclosure.

FIG. 5 is a flowchart of a motion control method according to some embodiments of the present disclosure.

FIG. 6 is a schematic diagram of a safety controller according to some embodiments of the present disclosure.

FIG. 7 is a schematic diagram of a robot according to some embodiments of the present disclosure.

### DETAILED DESCRIPTION

Many specific details are set forth in the description below to facilitate full understanding of the present disclosure. The present disclosure may be implemented in many ways different from the contents described herein. Those skilled in the art may make similar promotions without violating the meaning of the present disclosure, and therefore the present disclosure is not limited by the specific implementations below.

The terms used in one or more embodiments of the present disclosure are solely for the purpose of describing a particular embodiment and are not intended to limit the one or more embodiments of the present disclosure. The terms “a/an”, “said” and “the” in the singular form used in the one or more embodiments and appended claims of the present disclosure are also intended to include the plural form, unless the context clearly indicates other meaning. It may also be understood that the term “and/or” as used herein refers to any or all possible combinations of one or more associated listed items.

It may be understood that although the terms first, second, third, etc. may be used to describe various information in the one or more embodiments of the present disclosure, such information should not be limited to these terms. These terms are used only to distinguish information in the same type from one another. For example, without departing from the scope of one or more embodiments of the present disclosure, the first information may also be referred to as the second information, and similarly, the second information may be referred to as the first information. Depending on the context, words “if” and “in case that” used here may be interpreted as “when”, “while”, or “in response to determining . . . ”.

First, terms involved in one or more embodiments of the present disclosure is explained.

Servo control: In order to meet a certain purpose, generating motion and controlling the motion of an object is one of important activities. The servo control is effective control of variations, such as a position, a speed and an acceleration of the motion of the object.

Encoder: The encoder is a device that encoding a signal (such as bit stream) or data into a signal form for communication, transmission, and storage. The encoder converts angular displacement or linear displacement into electrical signals, in which the former is called an encoding disk, and the latter is called an encoding ruler. According to a read-out way, the encoder may be divided into a contact encoder and a non-contact encoder. According to a working principle, the encoder may be divided into an incremental encoder and an absolute encoder. The incremental encoder converts displacement into a periodic electrical signal, and then converts the periodic electrical signal into a counting pulse. A number of pulses represents a size of the displacement. Each position of the absolute encoder corresponds to a certain digital code, so its indicated value is only related to a start position and an end position of measurement, and has nothing to do with an intermediate process of the measurement.

Differential signal: The differential signal uses one value to represent a difference between two physical quantities. The differential signal is also known as a differential-mode signal, relative to a common-mode signal.

Generally, a position detection component (such as an encoder) is a key component of the servo control, widely used in many areas such as an industrial robot, a computer numerical control machine tool, an automobile, and a medical device. The encoder is used to detect angular displacement, linear displacement and other position information of a measured object, and converts the position information into an electrical signal that is easy to handle so as to control motion of a motor. An encoder output error may lead to abnormal motion of the device or even galloping, which may do harm to the device and people, so a fault state of the encoder is needed to be detected in time so that measures such as stopping the motion may be taken. Therefore, in a safety control system, it is usually needed to detect an abnormal situation of the encoder in time so as to take measures such as a shutdown to prevent an abnormal operation of the motor.

In the related art, the encoder may detect an internal intermediate variable (such as a voltage and magnetic field strength) via its internal processing circuit or its internal microcontroller unit (MCU), and output an abnormal state bit indicating abnormality of the encoder. However, the detection method may only detect abnormality of the intermediate variable, and final position output abnormality may not be reliably detected, thus abnormal states that may be detected are limited. Therefore, the motor cannot be effectively controlled to stop operating in time, timeliness and accuracy of motion control are poor, and is prone to cause dangerous accidents.

In order to solve the above problems, the embodiments of the present disclosure provide a position detection component. The position detection component may output three position signals (such as an absolute position signal and two relative position signals) via two position detection channels, and may determine whether the position detection component is abnormal via the three position signals, so as to control motion of a measured object. Determining whether the position detection component is abnormal via the three position signals may cover most of abnormal situations of the position detection component, which has high security and reliability, may effectively control the measured object to stop moving in time, thus greatly improving the timeliness and the accuracy of the motion control, and avoiding dangerous accidents.

In some examples, the position detection component adopts a dissimilar redundancy structure. A single position detection component has a redundant component for position detection, and the redundant component is electrically and physically isolated from an original component so as to avoid fault propagation. The redundant component is incremental differential output and the original component is absolute differential output, which avoids a situation that a same or similar fault results in failures occurring at two sets of position output components, and has high security and reliability.

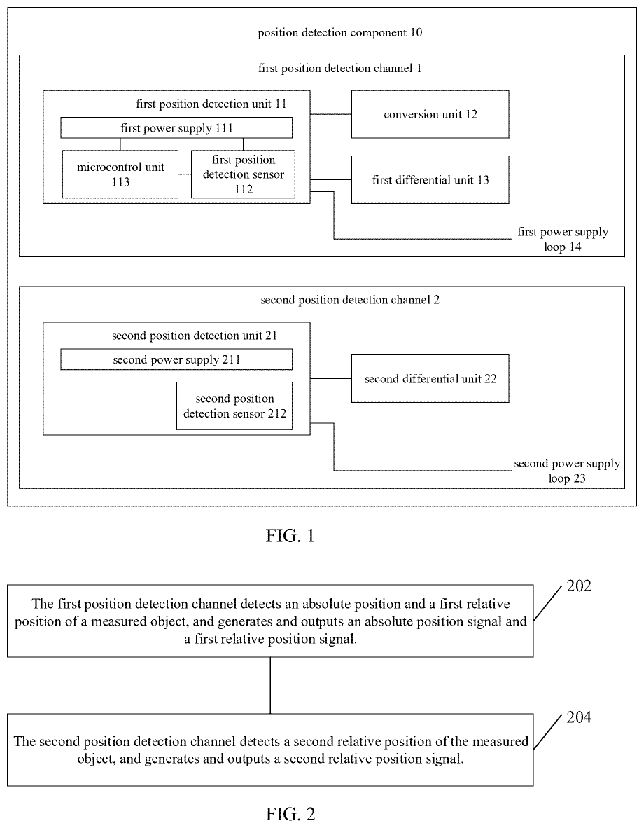

FIG. 1 is a schematic diagram of a position detection component according to some embodiments of the present disclosure. As shown in FIG. 1, the position detection component 10 includes a first position detection channel 1 and a second position detection channel 2.

In some embodiments, the first position detection channel 1 is configured to detect an absolute position and a first relative position of a measured object, and generate and output an absolute position signal and a first relative position signal: the second position detection channel 2 is configured to detect a second relative position of the measured object, and generate and output a second relative position signal: in which the absolute position signal, the first relative position signal and the second relative position signal are configured to determine an abnormal situation of the position detection component.

In some examples, the abnormal situation of the position detection component 10 includes the position detection component 10 being abnormal or the position detection component 10 being normal. The position detection component 10 may be a component for detecting a position of the measured object. For example, the position detection component 10 may be an encoder, such as an absolute encoder or an incremental encoder. Internal signal conversion principles and output modes of these two encoders are different. The absolute encoder may output an absolute position signal, and the incremental encoder may output a relative position signal.

Exemplarily; two position detection channels are set in the position detection component 10, that is, the first position detection channel 1 and the second position detection channel 2. As shown in FIG. 1, the first position detection channel 1 and the second position detection channel 2 may be set in parallel to output three position signals (such as the absolute position signal, the first relative position signal and the second relative position signal).

In some examples, the first position detection channel 1 may provide both an absolute position detection method and an incremental position detection method. The first position detection channel 1 is configured to detect the absolute position of the measured object via the absolute position detection method, and generate and output the absolute position signal according to the absolute position; and detect the first relative position of the measured object via the incremental position detection method, and generate and output the first relative position signal according to the first relative position. The absolute position detection method may preset and specify a mechanical origin, and determine the absolute position by performing a positioning calculation taking the mechanical origin as a basis.

In some examples, the second position detection channel 2 may provide the incremental position detection method. The second position detection channel 2 may detect the second relative position of the measured object via the incremental position detection method, and generate and output the second relative position signal according to the second relative position. The incremental position detection method may take the measured object as an origin, that is, the relative position is determined by performing calculation based on a current position, and there is no need to return to the mechanical origin.

Exemplarily, the first position detection channel 1 and the second position detection channel 2 in a circuit may use a common ground design. The use of the common ground design may simplify a power supply design and further simplify the circuit. It needs to be noted that the first position detection channel 1 and the second position detection channel 2 may not use the common ground design in the circuit, which is not limited in the present disclosure.

In some examples, in addition to the absolute position of the measured object, the absolute position signal may also include position state information generated based on an intermediate variable. For example, the position state information may be a hexadecimal number that may indicate different abnormal situations for the position detection component. For example, a hexadecimal number 0x00 may represent that there is no abnormality: a hexadecimal number 0x01 may represent that a lowest position is abnormal; and a hexadecimal number 0xFF may represent that all positions are abnormal. It needs to be noted that a specific abnormal situation may be resolved according to a protocol, and the protocol may be set based on requirements or may be set referring to related products.

The embodiments of the present disclosure provide two position detection channels (for example, the first position detection channel 1 and the second position detection channel 2) in the position detection component 10, and internal structures and output contents of the two position detection channels are different, that is, the position detection component 10 adopts the dissimilar redundancy structure. For example, the first position detection channel 1 adopts the incremental position detection output method and the absolute position detection output method, and the second position detection channel 2 adopts the incremental position detection output method, which avoids a situation that a same or similar fault results in failures occurring at both of the two position output components. In addition, the two position detection channels set in the position detection component 10 may be electrically and physically isolated so as to ensure that an abnormal channel does not affect operation of a normal channel.

In some embodiments, as shown in FIG. 1, the first position detection channel 1 includes a first position detection unit 11, a conversion unit 12 and a first differential unit 13, and the first position detection unit 11 is communicatively coupled to the conversion unit 12 and is communicatively coupled to the first differential unit 13.

In some embodiments, the first position detection unit 11 is configured to detect the absolute position of the measured object, and transmit the absolute position to the conversion unit 12: the conversion unit 12 is configured to obtain the absolute position signal by performing a level conversion on the absolute position: the first position detection unit 11 is further configured to detect the first relative position of the measured object, and transmit the first relative position to the first differential unit 13; and the first differential unit 13 is configured to obtain the first relative position signal by performing a differential conversion on the first relative position.

Exemplarily, the first position detection unit 11 may detect a position of the measured object and provide two digital signal outputs of the absolute position and the first relative position. The absolute position may communicate with the outside world by performing a level conversion via the conversion unit 12, and the first relative position may communicate with the outside world by performing a level conversion via the first differential unit 13.

In some examples, the absolute position output by the first position detection unit 11 is an absolute digital signal, and the first relative position output is an incremental digital signal.

Exemplarily, the conversion unit 12 may perform a level conversion on the absolute digital signal, to obtain an absolute position signal by converting the absolute position into a signal that conforms to a corresponding communication specification, so as to achieve the communication with the outside world. For example, the conversion unit 12 may be a level conversion unit.

In some examples, the absolute position signal may be supplied to the driving component, to detect the abnormal situation of the position detection component 10. Since the driving component is a component with large power and large interference, the position detection component 10 may also provide a digital signal isolation function, to isolate the absolute position output by the first position detection unit 11 and convert it into a signal that conforms to the corresponding communication specification, and obtain the absolute position signal to communicate with the outside world. That is to say, the conversion unit 12 may include an isolation unit and a level conversion unit. The stability of operation of the position detection component may be improved by an isolation design.

Exemplarily, the first differential unit 13 may convert an incremental digital signal into a differential signal, that is, the first relative position output by the first position detection unit 11 is converted into a pair of differential signals, to obtain the first relative position signal, so as to achieve communication with the outside world. For example, the first differential unit 13 may be a single-ended to differential unit, and a dedicated chip may be arranged in the single-ended to differential unit, to realize a differential signal conversion and convert the incremental digital signal into the differential signal, which may improve the anti-interference ability of the communication.

In some examples, the absolute position signal and the first relative position signal output by the first position detection channel 1 in the position detection component 10 may be transmitted by different communication methods. For example, the absolute position signal is transmitted in an RS485 communication method, and the first relative position signal is transmitted in an ABZ differential signal.

In some embodiments, as shown in FIG. 1, the first position detection unit 11 may include a first power supply 111, a first position detection sensor 112 and a microcontroller unit 113. The first power supply 111, the first position detection sensor 112 and the microcontroller unit 113 are interconnected. The first power supply 111 is configured to supply power to the first position detection sensor 112 and the microcontroller unit 113: the microcontroller unit 113 is configured to read the absolute position from the first position detection sensor 112; and the first position detection sensor 112 is configured to detect the absolute position and the first relative position of the measured object.

In some examples, the first power supply 111 may be a buck and regulator circuit. The first power supply 111 may provide a power supply that satisfies a specific voltage and wave requirements for the microcontroller unit 113 and the first position detection sensor 112.

In some examples, the microcontroller unit 113 (also known as MCU 113) may be a low-power advanced RISC machine (ARM) processor. The microcontroller unit 113 may communicate with the first position detection sensor 112 via a digital interface to read the absolute position and internal position state information detected by the first position detection sensor 112. Or, the microcontroller unit 113 may also communicate with the first position detection sensor 112 via an analog interface to read an analog signal obtained from a conversion by the first position detection sensor 112, and obtain the absolute position and the internal position state information based on an analog signal analysis.

For example, the microcontroller unit 113 may transmit the obtained absolute position information and position state information to the conversion unit 12, and the conversion unit 12 outputs the absolute position signal by isolating and converting the absolute position information and the position state information.

Exemplarily, the first position detection sensor 112 may also convert a strength signal into a voltage signal, a conversion result is transmitted to the microcontroller unit 113 via an analog interface or a digital interface after internal conditioning and analytical circuit processing.

In some examples, the first position detection sensor 112 may be a magnetic sensor or other forms of sensors, such as a photoelectric sensor, a capacitive sensor or an inductive sensors, which is not limited in the embodiments of the present disclosure.

In some embodiments, as shown in FIG. 1, the first position detection channel 1 may also include a first power supply loop 14. Power is supplied to the first power supply 111 via the first power supply loop 14. That is, the first position detection channel 1 may include the first power supply 111, the microcontroller unit 113, the first position detection sensor 112, the conversion unit 12, the first differential unit 13 and the first power supply loop 14.

In some examples, the first differential unit 13 may convert a received ABZ digital signal of an incremental encoder into a differential signal. The ABZ digital signal may be from the first position detection sensor 112 or the microcontroller unit 113.

In some embodiments, as shown in FIG. 1, the second position detection channel 2 includes a second position detection unit 21 and a second differential unit 22, and the second position detection unit 21 is communicatively coupled to the second differential unit 22.

In some embodiments, the second position detection unit 21 is configured to detect the second relative position of the measured object, and transmits the second relative position to the second differential unit 22; and the second differential unit 22 is configured to obtain the second relative position signal by performing a differential conversion on the second relative position.

In some embodiments, as shown in FIG. 1, the second position detection unit 21 includes a second power supply 211 and a second position detection sensor 212, and the second power supply 211 is connected with the second position detection sensor 212. The second power supply 211 is configured to supply power to the second position detection sensor 212; and the second position detection sensor 212 is configured to detect the second relative position of the measured object.

In some examples, structures and functions of the second power supply 211, the second position detection sensor 212, and the second differential unit 22 are similar with that of the first power supply 111, the first position detection sensor 112, and the first differential unit 13, which are not repeated herein to avoid repetition.

Exemplarily, as shown in FIG. 1, the second position detection channel 2 may also include a second power supply loop 23. Power is supplied to the second power supply 211 via the second power supply loop 23. That is, the second position detection channel 2 may include the second power supply 211, the second position detection sensor 212, the second differential unit 22 and the second power supply loop 23. Each component in the second position detection channel 2 is functionally similar to the corresponding part of the first position detection channel 1, which is not repeated herein to avoid repetition.

The embodiments of the present disclosure provide a position detection component. The position detection component may output three position signals (such as the absolute position signal and the two relative position signals) via two position detection channels, and may determine whether the position detection component is abnormal via the three position signals, so as to control motion of the measured object. Determining whether the position detection component is abnormal via the three position signals may cover most of abnormal situations of the position detection component, which has high security and reliability, and may effectively control the measured object to stop the motion in time, thus greatly improving the timeliness and the accuracy of the motion control, and avoiding dangerous accidents.

FIG. 2 is a flowchart of a position detection method according to some embodiments of the present disclosure. For example, the position detection method may be applied to the position detection component 10 in the above embodiments, and the position detection component 10 includes a first position detection channel 1 and a second position detection channel 2. As shown in FIG. 2, the method includes the following steps 202 and 204.

At step 202, the first position detection channel detects an absolute position and a first relative position of a measured object, and generates and outputs an absolute position signal and a first relative position signal.

At 204, the second position detection channel detects a second relative position of the measured object, and generates and outputs a second relative position signal.

In some embodiments, the absolute position signal, the first relative position signal and the second relative position signal may be used to determine an abnormal situation of the position detection component.

It needs to be noted that an execution sequence of the above step 202 and step 204 is not limited in the embodiments of the present disclosure. The step 202 may be executed before the step 204, or after the step 204, or at the same time as the step 204. In some examples, the execution sequence of the step 202 and the step 204 may be determined randomly:

The above is a schematic solution of a position detection method according to some embodiments of the present disclosure. It needs to be noted that a technical solution of the position detection method belongs to a same concept as a technical solution of the position detection component. For details of the technical solution of the position detection method that are not described in detail, reference may be made to the description of the technical solution of the position detection component. A beneficial effect produced by the position detection method provided in the embodiments of the present disclosure is similar to a beneficial effect produced by the position detection component in the above embodiments, which is not repeated herein to avoid repetition.

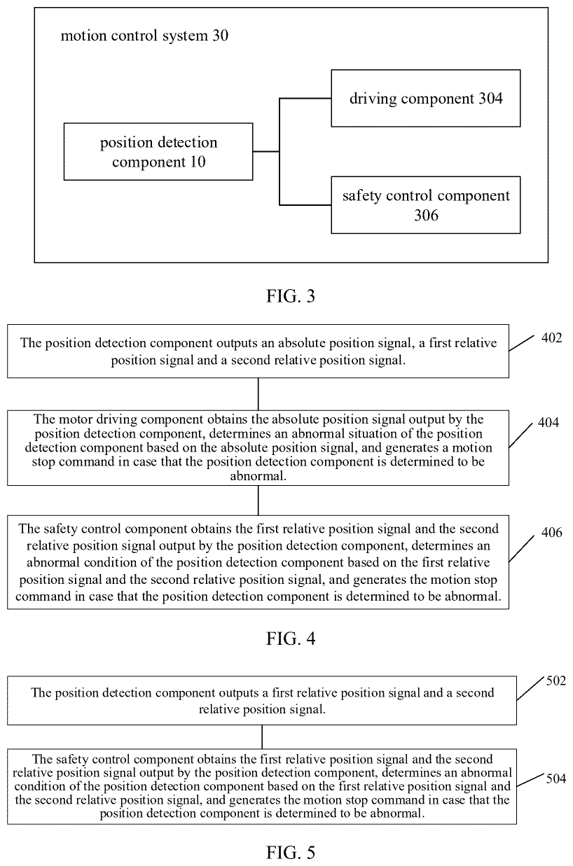

FIG. 3 is a schematic diagram of a motion control system according to some embodiments of the present disclosure. As shown in FIG. 3, the motion control system 30 includes a position detection component 10, a driving component 304 and a safety control component 306.

The position detection component 10 is configured to output an absolute position signal, a first relative position signal and a second relative position signal.

The driving component 304 is configured to obtain the absolute position signal output by the position detection component 10, determine an abnormal situation of the position detection component 10 based on the absolute position signal, and generate a motion stop command in case that the position detection component 10 is determined to be abnormal.

The safety control component 306 is configured to obtain the first relative position signal and the second relative position signal output by the position detection component 10, determine an abnormal situation of the position detection component 10 based on the first relative position signal and the second relative position signal, and generate a motion stop command in case that the position detection component is determined to be abnormal.

Exemplarily, the absolute position signal and the first relative position signal are output via a first position detection channel in the position detection component 10, and the second relative position signal is output via a second position detection channel in the position detection component 10.

For example, the position detection component 10 may be the position detection component 10 in the above embodiments (as shown in FIG. 1), the first position detection channel may be the first position detection channel 1 in the above embodiments (as shown in FIG. 1), and the second position detection channel may be the second position detection channel 2 in the above embodiment (as shown in FIG. 1).

In some examples, the driving component 304 may be coupled to an RS485 interface of the position detection component 10 via an RS485 interface to realized communication connection. The safety control component 306 may be coupled to the position detection component 10 via a differential incremental encoder signal interface to realized communication connection. Any device with a differential incremental encoder signal interface may be used as the safety control component 306 to connect with the position detection component 10, so as to realize a relative position detection of an incremental type.

Exemplarily, the motion stop command may control a motion component to stop moving. For example, the motion component may be a motor, or other related components to realize the motion, such as a brake, etc.

In some embodiments, at least one of the driving component 304 and the safety control component 306 generates the motion stop command to control the motion component to stop moving.

In some examples, when the driving component 304 determines that the position detection component 10 is abnormal, the driving component 304 may generate the motion stop command, and send the motion stop command to the motion component (such as a motor). The motion component stops moving the motion according to the motion stop command after the motion component receives the motion stop command.

In some examples, when the safety control component 306 determines that the position detection component 10 is abnormal, the safety control component 306 may also generate a motion stop command, and send the motion stop command to the driving component 304. The driving component 304 may send the motion stop command to the motion component (such as a motor), and the motion component may stop moving according to the motion stop command after receiving the motion stop command.

For example, the driving component 304 may control the motion component to stop moving when obtaining the motion stop command. If the driving component 304 detects a motion stop command generated and triggered by itself, and/or receives a motion stop command sent by the safety control component 306, it determines that the motion stop command is obtained and sends the motion stop command to the motion component to control the motion component to stop moving.

In some examples, the absolute position signal may be used as position feedback of the driving component 304, and to control the motion of the motion component, so as to achieve closed-loop control. If the position detection component 10 is determined to be normal based on the absolute position signal, the motion of the motion component may be controlled based on the absolute position information in the absolute position signal. For example, the driving component 304 may calculate a rotor angle of the motion component using the absolute position information, so as to realize directional control of a rotor magnetic field.

In the motion control system in the embodiments of the present disclosure, the position detection component may output three position signals, the driving component may analyze the absolute position signal so as to determine whether the position detection component is abnormal, and the safety control component may analyze the first relative position signal and the second relative position signal to determine whether the position detection component is abnormal. The three position signals output by the position detection component are not reused, which avoids a situation that a same or similar fault results in outputting failures by both of the two abnormality output components. That is to say, in the embodiments of the present disclosure, determining whether the position detection component is abnormal via the three position signals may cover most of abnormal situations of the position detection component, which has high security and reliability, and may effectively control the measured object to stop moving in time, thus greatly improving the timeliness and the accuracy of the motion control.

In some embodiments, the absolute position signal may include the absolute position information and/or the position state information.

In some embodiments, the driving component 304 is configured to obtain an analytical result by analyzing the absolute position signal; and determine the position detection component 10 to be abnormal in case that the analytic result includes position state information and the position state information is abnormal; and/or, determine the position detection component 10 to be abnormal in case that the analytic result does not include absolute position information.

Exemplarily, the position state information is an abnormal identifier determined by the first position detection channel 1 based on an internal intermediate variable, for example, the position state information may be an abnormal code, used to identify whether the position detection component 10 is abnormal. For example, the abnormality of the position detection component 10 caused by abnormality of the intermediate variable may be identified based on the position state information. Therefore, the position state information may be obtained by analyzing the absolute position signal, and it is determined whether the position state information represents that the position detection component 10 is abnormal. If it is, the position detection component 10 is determined to be abnormal.

Exemplarily, when the obtained position state information is normal, whether the analytical result of the driving component 304 includes the absolute position information may be further determined. The absolute position information refers to information related to an absolute position of the measured object. When the analytical result does not include the absolute position information, it indicates that position transmission is interrupted, thus it is determined that the position detection component is abnormal.

In some examples, the position detection component 10 is determined to be abnormal in case that the analytic result includes the position state information and the 10 position state information is abnormal. The position detection component 10 is determined to be abnormal in case that the analytic result does not include the absolute position information.

In some embodiments, the driving component 304 is configured to, in case that the analytic result includes the absolute position information, determine velocity information according to the absolute position information: determine an amplitude velocity according to the velocity information; and determine the position detection component 10 to be abnormal in case that the amplitude velocity exceeds a first velocity threshold.

In some examples, if the analytic result of the driving component 304 includes the absolute position information, it indicates that the position transmission is not interrupted, and the transmitted absolute position information may be analyzed, to determine whether the position detection component 10 is abnormal.

Exemplarily, the amplitude velocity refers to a maximum velocity and/or a minimum velocity in each target velocity included in the velocity information; and the first velocity threshold refers to a pre-set maximum velocity that is able to be reached by the measured object or a pre-set minimum velocity limited for the measured object in an actual system, which may be set in advance based on experience or needs for determining whether a current velocity is too high or too low:

In some examples, a differential operation may be performed on each absolute position in the output absolute position information to obtain a target velocity corresponding to each absolute position; and the respective target velocities constitute the velocity information. Or, low-pass filtering may be performed on each target velocity calculated by the differential operation to remove high-frequency noise and interference, and then an amplitude velocity may be determined from each target velocity included in the velocity information. If the amplitude velocity exceeds the first velocity threshold (such as a maximum velocity that an actual system may reach or a minimum velocity that the actual system may limit), the driving component 304 may determine the velocity to be abnormal, which may be caused by abnormality of a system velocity or by abnormality of the position detection component 10.

The embodiments of the present disclosure may detect abnormality caused by an output position based on velocity abnormality, which has high security and reliability, thus can effectively control to stop the motion in time, and avoid dangerous accidents.

In some embodiments, the safety control component 306 is configured to determine a first velocity according to the first relative position signal, and determine a second velocity according to the second relative position signal: determine a first velocity difference between the first velocity and the second velocity according to the first velocity and the second velocity; and determine the position detection component 10 to be abnormal in case that the first velocity difference is greater than a first difference threshold.

In some examples, the first difference threshold is a pre-set value used to determine whether a velocity difference calculated based on relative positions between different channels is too large. For example, the first difference threshold may be set to 10 or 20, etc. The embodiments of the present disclosure do not limit a value of the first difference threshold.

In some examples, the first velocity may be obtained by performing a differential operation on the first relative position signal of the first position detection channel 1, and the second velocity may be obtained by performing a differential operation on the second relative position signal of the second position detection channel 2. The first velocity is compared with the second velocity, if a velocity difference between the first velocity and the second velocity (such as the first velocity difference) exceeds the set first difference threshold, it indicates that a relative position difference detected by different position detection channels is too large. In this case, the safety control component 306 may determine that the position detection component 10 is abnormal.

In other examples, it is also possible to determine a relative position difference by comparing relative position information between a first relative position in the first relative position signal and a second relative position in the second relative position signal, without calculating the first velocity and the second velocity. If a difference between the first relative position and the second relative position is too large, the position detection component 10 may be determined to be abnormal.

In the embodiments of the present disclosure, the safety control component may read two relative position signals output by the position detection component, obtain velocity information according to the two relative position signals respectively, and compare a velocity difference between two channels. If it exceeds the first difference threshold, the position detection component is determined to be abnormal. Through the two relative position signals provided by the position detection component, abnormality caused by an output position may be detected based on a velocity difference or a position difference, which has high security and reliability, thus it may effectively control to stop the motion in time, and avoid dangerous accidents.

In some embodiments, the safety control component 306 is configured to send the first velocity and the second velocity to the driving component 304. The driving component 304 is also configured to receive the first velocity and the second velocity.

In some embodiments, the driving component 304 is configured to determine a target velocity according to the absolute position signal: determine a second velocity difference between the target velocity and the first velocity, and a third velocity difference between the target velocity and the second velocity; and determine the position detection component to be abnormal in case that the second velocity difference or the third velocity difference exceeds a second difference threshold.

Exemplarily, the first velocity is determined by the safety control component 306 based on the first relative position signal, and the second velocity is determined by the safety control component 306 based on the second relative position signal. The safety control component 306 may send the determined first velocity and second velocity to the driving component 304.

In some examples, the second difference threshold is a pre-set value used to determine a velocity difference between a velocity calculated based on the absolute position and a velocity calculated based on the relative positions between different channels. For example, the second difference threshold may be set to 10 or 20 etc. The second difference threshold may be the same or different from the first difference threshold. The embodiments of the present disclosure do not limit a value of the second difference threshold.

In some examples, a target velocity determined by the driving component 304 may be compared with the two velocities determined by the safety control component 306 (such as the first velocity and the second velocity) separately. If any difference in two comparison results exceeds a set second difference threshold, it indicates that a difference between the absolute position and the two relative positions detected by different channels are too large. In this way, the position may be determined to be abnormal, thus it is determined that the position detection component 10 is abnormal.

In some examples, two-way communication may be set between the driving component 304 and the safety control component 306. The safety control component 306 may determine two velocities (such as the first velocity and the second velocity) based on two obtained relative position signals, and transmit the two velocities to the driving component 304. The driving component 304 may determine a difference between each target velocity determined by itself and the first velocity or the second velocity to determine whether the position detection component 10 is abnormal. For example, when either of a second velocity difference between the target velocity and the first velocity or a third velocity difference between the target velocity and the second velocity exceeds the second difference threshold, the position detection component 10 is determined to be abnormal.

In other examples, the safety control component 306 may also determine the first velocity and the second velocity based on an obtained first relative position signal and an obtained second relative position signal, and determine whether the first velocity and the second velocity are abnormal. If there is no abnormality, that is, the two velocities are consistent, any one of the two velocities is transmitted to the driving component 304, so that the driving component 304 may compare the target velocity determined by itself based on an absolute position signal with a received velocity determined based on a relative position signal (such as the first velocity or the second velocity), to determine whether the position detection component 10 is abnormal.

In the embodiments of the present disclosure, if neither the driving component nor the safety control component detects abnormality based on position signals collected by themselves, whether the position detection component is abnormal may be determined based on the three position signals output by the position detection component, and the abnormality may be determined not only by using an intermediate variable but also by an output position, which may cover almost all abnormal situations, and has high security and reliability.

In some embodiments, the position detection component 10 includes the first position detection channel I and the second position detection channel 2. The first position detection channel 1 is configured to detect the absolute position and the first relative position of the measured object, and generate and output the absolute position signal and the first relative position signal: the second position detection channel 2 is configured to detect the second relative position of the measured object, and generate and output the second relative position signal: the driving component 304 is configured to obtain the absolute position signal output by the first position detection channel; and the safety control component 306 is configured to obtain the first relative position signal output by the first position detection channel and the second relative position signal output by the second position detection channel.

Two position detection channels are provided in the position detection component 10 in the embodiments of the present disclosure, and internal structures and output contents of the two position detection channels are different, that is, the position detection component 10 adopts a dissimilar redundance structure, and the two position detection channels in the position detection component are electrically and physically isolated, which ensures that an abnormal channel does not affect operation of a normal channel. In addition, the second position detection channel 2 adopts an incremental position detection and output method, and the first position detection channel 1 adopts an incremental position detection and output method and an absolute position detection and output method, which avoids a situation that a same or similar fault results in failures occurring at two sets of position output components.

FIG. 4 is a flowchart of a motion control method according to some embodiments of the present disclosure. For example, the motion control method may be applied to the motion control system 30 in the above embodiments. The motion control system 30 includes a position detection component, a driving component and a safety control component. As shown in FIG. 4, the method includes the following steps 402, 404, and 406.

At step 402, the position detection component outputs an absolute position signal, a first relative position signal and a second relative position signal.

Exemplarily, the absolute position signal and the first relative position signal are output via a first position detection channel in the position detection component, and the second relative position signal is output via a second position detection channel in the position detection component.

At step 404, the motor driving component obtains the absolute position signal output by the position detection component, determines an abnormal situation of the position detection component based on the absolute position signal, and generates a motion stop command in case that the position detection component is determined to be abnormal.

At step 406, the safety control component obtains the first relative position signal and the second relative position signal output by the position detection component, determines an abnormal situation of the position detection component based on the first relative position signal and the second relative position signal, and generates the motion stop command in case that the position detection component is determined to be abnormal.

It needs to be noted that an execution sequence of above steps 404 to 406 is not limited in the embodiments of the present disclosure. The steps may be executed sequentially, randomly, or simultaneously. For example, the step 404 may be executed before the step 406, or after the step 406, or at the same time as the step 406.

FIG. 5 is a flowchart of a motion control method according to some embodiments of the present disclosure. The method is applied to a motion control system including a position detection component, a driving component and a safety control component. As shown in FIG. 5, the method includes the following steps 502 and 504.

At step 502, the position detection component outputs a first relative position signal and a second relative position signal.

At step 504, the safety control component obtains the first relative position signal and the second relative position signal output by the position detection component, determines an abnormal situation of the position detection component based on the first relative position signal and the second relative position signal, and generates a motion stop command in case that the position detection component is determined to be abnormal.

It needs to be noted that a technical solution of the motion control method belongs to a same concept as a technical solution of the motion control system. For details of the technical solution of the motion control method that are not described in detail, reference may be made to the description of the technical solution of the motion control system. A beneficial effect produced by the position detection method provided in the embodiments of the present disclosure is similar to a beneficial effect produced by the position detection component in the above embodiments, which is not repeated herein to avoid repetition.

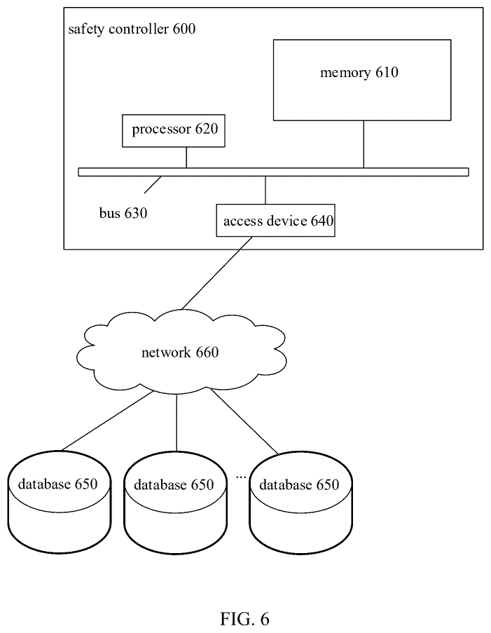

FIG. 6 is a schematic diagram of a safety controller according to some embodiments of the present disclosure. As shown in FIG. 6, the safety controller 600 includes a memory 610 and a processor 620. The processor 620 is connected to the memory 610 via a bus 630, and databases 650 are used to store data.

In some examples, the safety controller 600 also includes an access device 640. The access device 640 enables the safety controller 600 to perform communication via one or more networks 660. Examples of these networks include one or a combination of a public switched telephone network (PSTN), a local area network (LAN), a wide area network (WAN), a personal area network (PAN) or the Internet. The access device 640 may include one or more of any type of wired or wireless network interfaces (e.g., network interface controller (NIC)), such as a wireless interface of an IEEE802.11 wireless local area network (WLAN), an interface of a worldwide interoperability for microwave access (Wi-MAX), an Ethernet interface, a universal serial bus (USB) interface, a cellular network interface, a Bluetooth interface, a near field communication (NFC) interface, and so on.

In some examples, the above parts of the safety controller 600 and other parts not shown in the FIG. 6 may also be connected to each other, for example via a bus. For example, the schematic diagram of the safety controller shown in the FIG. 6 is exemplary only and is not a limitation on the scope of the present disclosure. Those skilled in the art may add or replace other parts as needed.

In some examples, the safety controller 600 may be any type of stationary or mobile safety controller, including a mobile computer or a mobile safety controller (e.g., a tablet, a personal digital assistant, a laptop computer, a netbook, etc.), a mobile phone (e.g., a smart phone), a wearable safety controller (e.g., a smart watch, a smart glass, etc.) or other types of mobile devices, or a stationary safety controller such as a desktop computer or a personal computer (PC). The safety controller 600 may also be a mobile or stationary server.

The processor 620 is used to execute the following computer executable instructions to obtain the absolute position signal, the first relative position signal and the second relative position signal output by the position detection component, and determine the abnormal situation of the position detection component based on the absolute position signal, the first relative position signal and the second relative position signal. A motion stop command is generated in case that the position detection component is determined to be abnormal.

It needs to be noted that a technical solution of the safety controller belongs to a same idea as a technical solution of the above position detection component or the above motion control system. For the technical solution of the safety controller, reference may be made to the description of the technical solution of the above position detection component or the above motion control system.

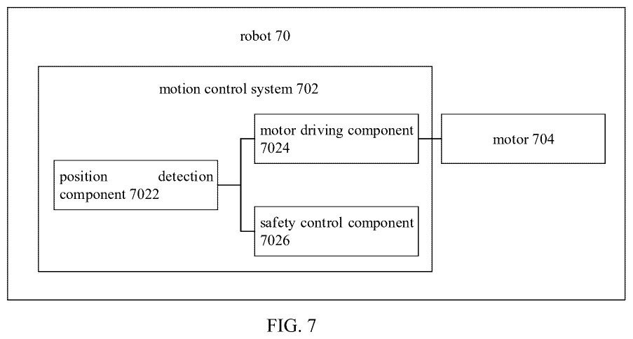

FIG. 7 is a schematic diagram of a robot according to some embodiments of the present disclosure. As shown in FIG. 7, a robot 70 includes a motion control system 702 and a motor 704. The motion control system 702 includes a position detection component 7022, a motor driving component 7024 and a safety control component 7026. It needs to be noted that the position detection component 7022 may be the position detection component 10 in the above embodiments, the motor driving component 7024 may be the driving component 304 in the above embodiments, and the safety control component 7026 may be the safety control component 306 in the above embodiments.

The position detection component 7022 is configured to output an absolute position signal, a first relative position signal and a second relative position signal, in which the absolute position signal and the first relative position signal are output via a first position detection channel in the position detection component 7022, and the second relative position signal is output via a second position detection channel in the position detection component 7022.

The motor driving component 7024 is configured to obtain the absolute position signal output by the position detection component 7022, determine an abnormal situation of the position detection component 7022 based on the absolute position signal, and trigger a motion stop command in case that the position detection component 7022 is determined to be abnormal.

The safety control component 7026 is configured to obtain the first relative position signal and the second relative position signal output by the position detection component 7022, determine an abnormal situation of the position detection component 7022 based on the first relative position signal and the second relative position signal, and send a motion stop command to the motor driving component 7024 in case that the position detection component 7022 is determined to be abnormal.

The motor driving component 7024 is configured to control the motor 704 to stop operating based on the motion stop command.

For beneficial effects achieved by the motion control method, the safety controller, and the robot in the embodiments of the present disclosure, reference may be made to the beneficial effect of the safety control system in the above embodiments, which will not be repeated herein.

Specific embodiments of the present disclosure are described above. Other embodiments are within the scope of the appended claims. In some cases, actions or steps described in the claims may be performed in an order different from the order in the embodiments and still achieve a desired result. In addition, a process depicted in the accompanying drawings does not necessarily need to follow a specific sequence or a consecutive order to achieve the desired result. In some embodiments, multitasking and parallel processing are also possible or may be advantageous.

The computer instruction includes computer program codes. The computer program codes may be in a form of source codes, object codes, an executable file or some intermediate forms. The computer readable media may include any entity or apparatus, any recording medium, any USB flash disk, any mobile hard disk drive, any diskette, any optical disc, any computer memory, any read-only memory (ROM), any random access memory (RAM), any electric carrier signal, any telecommunication signal and software distribution medium that is capable of carrying the computer program codes.

It needs to be noted that, in order to simplify description the present disclosure, embodiments of the present disclosure are expressed as a series of action combinations, but it would be appreciated by those skilled in the art that the present disclosure is not limited to the order of the actions, because some steps may be executed in other orders or be executed at the same time. In addition, it would be further appreciated by those skilled in the art that embodiments described in the specification are preferred embodiments, actions and modules involved therein may not be necessary for the present disclosure.

In above embodiments, descriptions of respective embodiments are emphasized differently, and parts that are not detailed in some embodiments may refer to relevant descriptions of other embodiments. The above embodiments of the present disclosure are only intended to assist in elaborating the present disclosure. The above embodiments do not elaborate on all the details and do not limit the disclosure to specific embodiments described above. Obviously, based on the content of the present disclosure, many modifications and changes may be made. The present disclosure selects and specifically describes these embodiments for the purpose of better explaining the principle and practical application of the present disclosure, so that those skilled in the art may better understand and use the present disclosure. The present disclosure is only limited by the appended claims, all scope covered by the claims and equivalents.

1. A motion control system, comprising:
a position detection component, configured to output an absolute position signal, a first relative position signal and a second relative position signal, wherein the absolute position signal and the first relative position signal are output via a first position detection channel in the position detection component, and the second relative position signal is output via a second position detection channel in the position detection component;
a driving component, configured to obtain the absolute position signal output by the position detection component, determine an abnormal situation of the position detection component based on the absolute position signal, and generate a motion stop command in case that the position detection component is determined to be abnormal; and
a safety control component, configured to obtain the first relative position signal and the second relative position signal output by the position detection component, determine an abnormal situation of the position detection component based on the first relative position signal and the second relative position signal, and generate the motion stop command in case that the position detection component is determined to be abnormal.

2. The system of claim 1, wherein the driving component is configured to:
obtain an analytical result by analyzing the absolute position signal; and
determine the position detection component to be abnormal in case that the analytic result comprises position state information and the position state information is abnormal; and/or,
determine the position detection component to be abnormal in case that the analytic result does not comprise absolute position information.

3. The system of claim 2, wherein the driving component is configured to:
in case that the analytic result comprises the absolute position information, determine velocity information according to the absolute position information;
determine an amplitude velocity according to the velocity information; and
determine the position detection component to be abnormal in case that the amplitude velocity exceeds a first velocity threshold.

4. The system of claim 1, wherein the safety control component is configured to:
determine a first velocity according to the first relative position signal, and determine a second velocity according to the second relative position signal;
determine a first velocity difference between the first velocity and the second velocity according to the first velocity and the second velocity; and
determine the position detection component to be abnormal in case that the first velocity difference is greater than a first difference threshold.

5. The system of claim 1, wherein the safety control component is configured to determine a first velocity according to the first relative position signal, determine a second velocity according to the second relative position signal, and send the first velocity and the second velocity to the driving component; and
the driving component is further configured to receive the first velocity and the second velocity.

6. The system of claim 5, wherein the driving component is configured to:
determine a target velocity according to the absolute position signal;
determine a second velocity difference between the target velocity and the first velocity, and a third velocity difference between the target velocity and the second velocity; and
determine the position detection component to be abnormal in case that the second velocity difference or the third velocity difference exceeds a second difference threshold.

7. The system of claim 1, wherein the position detection component comprises the first position detection channel and the second position detection channel; wherein:
the first position detection channel is configured to detect an absolute position and a first relative position of a measured object, and generate and output the absolute position signal and the first relative position signal;
the second position detection channel is configured to detect a second relative position of the measured object, and generate and output the second relative position signal;
the driving component is configured to obtain the absolute position signal output by the first position detection channel; and
the safety control component is configured to obtain the first relative position signal output by the first position detection channel and the second relative position signal output by the second position detection channel.

8. A position detection component, comprising:
a first position detection channel, configured to detect an absolute position and a first relative position of a measured object, and generate and output an absolute position signal and a first relative position signal; and
a second position detection channel, configured to detect a second relative position of the measured object, and generate and output a second relative position signal;
wherein the absolute position signal, the first relative position signal and the second relative position signal are configured to determine an abnormal situation of the position detection component.

9. The position detection component of claim 8, wherein the first position detection channel comprises a first position detection unit, a conversion unit and a first differential unit, and the first position detection unit is communicatively coupled to the conversion unit and is communicatively coupled to the first differential unit; wherein:
the first position detection unit is configured to detect the absolute position of the measured object, and transmit the absolute position to the conversion unit;
the conversion unit is configured to obtain the absolute position signal by performing a level conversion on the absolute position;
the first position detection unit is further configured to detect the first relative position of the measured object, and transmit the first relative position to the first differential unit; and
the first differential unit is configured to obtain the first relative position signal by performing a differential conversion on the first relative position.

10. The position detection component of claim 9, wherein the first position detection unit comprises a first power supply, a first position detection sensor and a microcontroller unit; and the first power supply, the first position detection sensor and the microcontroller unit are interconnected; wherein:
the first power supply is configured to supply power to the first position detection sensor and the microcontroller unit;
the microcontroller unit is configured to read the absolute position from the first position detection sensor; and
the first position detection sensor is configured to detect the absolute position and the first relative position of the measured object.

11. The position detection component of claim 8, wherein the second position detection channel comprises a second position detection unit and a second differential unit; and the second position detection unit is communicatively coupled to the second differential unit; wherein:
the second position detection unit is configured to detect the second relative position of the measured object, and transmits the second relative position to the second differential unit; and
the second differential unit is configured to obtain the second relative position signal by performing a differential conversion on the second relative position.

12. The position detection component of claim 11, the second position detection unit comprises a second power supply and a second position detection sensor; and the second power supply is connected with the second position detection sensor; wherein:
the second power supply is configured to supply power to the second position detection sensor; and
the second position detection sensor is configured to detect the second relative position of the measured object.

13. A robot, comprising: a motion control system and a motor; wherein
the motion control system comprises a position detection component, a motor driving component and a safety control component; wherein:
the position detection component is configured to output an absolute position signal, a first relative position signal and a second relative position signal, wherein the absolute position signal and the first relative position signal are output via a first position detection channel in the position detection component, and the second relative position signal is output via a second position detection channel in the position detection component;
the motor driving component is configured to obtain the absolute position signal output by the position detection component, determine an abnormal situation of the position detection component based on the absolute position signal, and trigger a motion stop command in case that the position detection component is determined to be abnormal;
the safety control component is configured to obtain the first relative position signal and the second relative position signal output by the position detection component, determine an abnormal situation of the position detection component based on the first relative position signal and the second relative position signal, and send the motion stop command in case that the position detection component is determined to be abnormal; and
the motor driving component is configured to control the motor to stop operating based on the motion stop command.

14. The robot of claim 13, wherein the motor driving component is configured to:
obtain an analytical result by analyzing the absolute position signal; and
determine the position detection component to be abnormal in case that the analytic result comprises position state information and the position state information is abnormal; and/or,
determine the position detection component to be abnormal in case that the analytic result does not comprise absolute position information.

15. The robot of claim 14, wherein the motor driving component is configured to:
in case that the analytic result comprises the absolute position information, determine velocity information according to the absolute position information;
determine an amplitude velocity according to the velocity information; and
determine the position detection component to be abnormal in case that the amplitude velocity exceeds a first velocity threshold.

16. The robot of claim 13, wherein the safety control component is configured to:
determine a first velocity according to the first relative position signal, and determine a second velocity according to the second relative position signal;
determine a first velocity difference between the first velocity and the second velocity according to the first velocity and the second velocity; and
determine the position detection component to be abnormal in case that the first velocity difference is greater than a first difference threshold.

17. The robot of claim 13, wherein the safety control component is configured to determine a first velocity according to the first relative position signal, determine a second velocity according to the second relative position signal, and send the first velocity and the second velocity to the motor driving component; and
the motor driving component is further configured to receive the first velocity and the second velocity.

18. The robot of claim 17, wherein the motor driving component is configured to:
determine a target velocity according to the absolute position signal;
determine a second velocity difference between the target velocity and the first velocity, and a third velocity difference between the target velocity and the second velocity; and
determine the position detection component to be abnormal in case that the second velocity difference or the third velocity difference exceeds a second difference threshold.

19. The robot of claim 13, wherein the position detection component comprises the first position detection channel and the second position detection channel; wherein:
the first position detection channel is configured to detect an absolute position and a first relative position of a measured object, and generate and output the absolute position signal and the first relative position signal;
the second position detection channel is configured to detect a second relative position of the measured object, and generate and output the second relative position signal;
the motor driving component is configured to obtain the absolute position signal output by the first position detection channel; and
the safety control component is configured to obtain the first relative position signal output by the first position detection channel and the second relative position signal output by the second position detection channel.
